(19) United States
(12) Patent Application Publication
(10) Pub. No.: US 2006/0064391 A1
(43) Pub. Date: Mar. 23, 2006

(54) System and method for a secure transaction module

(76) Inventors: Andrew Petrov, Princeton, NJ (US); Scott Goldthwaite, Hingham, MA (US); William Graylin, Saugus, MA (US)

Correspondence Address: AKC PATENTS, 215 GROVE ST., NEWTON, MA, 02466, US

(21) Appl. No.: 11/226,823

(22) Filed: Sep. 14, 2005

Related U.S. Application Data
(60) Provisional application No. 60/611,455, filed on Sep. 20, 2004.

(51) Int. Cl. H04L 9/00

(52) U.S. Cl. 705/65

(57) ABSTRACT

A secure electronic payment transaction system includes a Secure Transaction Module (STM) and a host device. The STM includes hardware and software components that meet the security requirements of the payment card industry and provide secure payment transactions utilizing banking cards. The host device includes a communication modem for connecting to financial institutions via a network connection. The STM connects to the host device via an interface and communicates with the financial institutions via the host device's communication modem. The STM is self-sufficient and can be connected to any host device over any interface.

### CROSS REFERENCE TO RELATED CO-PENDING APPLICATIONS

This application claims the benefit of U.S. provisional application Ser. No. 60/611,455 filed on Sep. 20, 2004 and entitled SYSTEM AND METHOD FOR A SECURE TRANSACTION MODULE, which is commonly assigned and the contents of which are expressly incorporated herein by reference.

### FIELD OF THE INVENTION

The present invention relates to a system and method for a secure transaction module and more particularly to a secure transaction module that performs electronic transactions by interacting with payment cards or authentication cards.

### BACKGROUND OF THE INVENTION

Payment transactions have evolved from hard currency to checks and banking cards. Banking cards include credit and debit cards that store a customer's account number and other necessary information to conduct a payment transaction. This information is stored either in a magnetic strip for a magnetic stripe card or in an embedded Integrated Circuit (IC), as is the case in a smart card.

In a typical “face-to-face” payment transaction, the customer or sales clerk swipes the payment card through a merchant's Point of Sale (POS) terminal. The merchant's POS terminal reads the information that is stored in the banking card, connects to a payment network to validate and approve the payment transaction and prints a receipt. The customer signs the receipt to complete the payment transaction. For payment transactions involving debit cards the customer is requested to type in or enter a Personal Identification Number (PIN) to authorize the transaction and/or sign the printed receipt. The process of swiping the card through the POS and either signing the sales receipt or typing in a PIN provides proof that the card holder is present with the payment card at the time of purchase, creating a “Card Present” type of payment transaction.

In the recent years, with the introduction of eCommerce, consumers can purchase goods and services from remote merchants via the Internet, or the telephone. Credit cards and debit cards have been the main payment instrument for these eCommerce order transactions. For these types of “non face-to-face” payment transaction, there is no merchant POS terminal to accept the payment card, and accordingly, no means of verifying the presence of the payment card (i.e., card-not-present (CNP)) and the identity of the customer. This lack of authentication of the customer and the payment card presents an opportunity for fraud. For example, a person other than the cardholder may obtain the payment card number and expiration date from a discarded payment form and use them to make new purchases. As a result the merchant pays significantly higher transaction fees for CNP transactions than those for Card Present transactions.

Mobile phones have been combined with card readers to provide a new range of POS terminals for conducting financial services transactions. While there are several card readers available today for mobile phones (Semtek, Symbol, Apriva), these prior art card readers require a customized interface for each type of mobile communication device. Card readers may also be connected to a mobile phone by implementing a connection to an existing Subscriber Identity Module (SIM) connector on a mobile phone as described in the prior art patent application entitled “Communication Method and Apparatus Improvements” (PCT International Publication Number WO 99/66752), the entire content of which is incorporated herein by reference. U.S. patent application Ser. No. 10/695,585 and U.S. application Ser. No. 10/729,043 describe the use of smart cards and magnetic cards, respectively, in connection with a SIM card for conducting payment transactions and digital goods fulfillment, the entire contents of which is incorporated herein by reference.

Accordingly, there is a need for a universal secure transaction module that satisfies the certification requirements of the various financial institutions and can be used with any communication device and any type of user and system interfaces.

### SUMMARY OF THE INVENTION

In general, in one aspect of this invention features a secure electronic payment transaction system that includes a secure transaction module (STM) and a host device. The STM comprises one or more hardware components and one or more software components for providing secure payment transactions utilizing banking cards. The host device comprises a communication modem for connecting to a financial institution via a network. The STM is adapted to connect to the host device via an interface and to communicate with the financial institution via the communication modem. The STM is also adapted to receive payment transaction commands from the host device via the interface.

Implementations of this aspect of the invention include the following. The STM provides a cryptographic boundary so that the secure payment transactions are not compromised by the host device or other external devices. The cryptographic boundary comprises security measures that detect and prevent tampering with the hardware components and the software components. All sensitive information processed within the cryptographic boundary is encrypted before being exposed to the host device. The hardware components are contained in a Printed Circuit Board Assembly (PCBA) of the STM and comprise a microprocessor, a secure microprocessor and a memory. The secure microprocessor may be integrated within the microprocessor. The memory may be memory embedded in the microprocessor, memory embedded in the secure microprocessor, erasable secure memory embedded in the PCBA, or permanent secure storage memory embedded in the PCBA. The hardware components may further comprise a display screen, a keypad, a clock and a life-time battery providing power to the secure memory and the clock. The hardware components may further comprise a first connector adapted to connect to a magnetic card reader, a second connector adapted to connect to a smart card reader, and a third connector adapted to connect to a secure authentication module (SAM). Additional connectors may be adapted to connect to additional card readers including contactless card readers or biometric readers. The hardware components may further comprise a crypto coprocessor, and the crypto coprocessor may be adapted to perform complex mathematical calculations required for cryptographic data transformations. The microprocessor is powered by an external power supply, and the external power supply may be provided by the host device. The interface provides a processor to processor interface between the STM and the host device and it may be a serial interface, parallel interface, SIM card interface, or a multimedia card interface. The hardware components may further comprise additional interfaces for connecting to other external devices. These additional interfaces may be serial interfaces, parallel interfaces, infrared interfaces, or Bluetooth. The host device may be a mobile phone, a personal computer, POS terminal, a personal digital assistant (PDA), a set-top box, a vending machine, a wired telephone, a computer controlling a car, or an electronic lock preventing access to valuable assets. The software components comprise a secure transaction application and a transaction application commanding protocol (TACP). The TACP provides external control of the secure transaction application. The software components further comprise a printing device protocol, a screen control protocol, a user input control protocol, a magnetic card reader control protocol, a smart card reader control protocol, and other card reader control protocols. The printing device protocol directs printed forms of the secure transaction application to a printer connected to the host device. The screen control protocol directs video output of the secure transaction application to a screen display of the host device. The user input control protocol directs user input to the secure transaction application to a keyboard of the host device. The magnetic card reader control protocol directs magnetic card information input to a magnetic card reader connected to the host device. The smart card reader control protocol directs smart card information input to a smart card reader connected to the host device. The STM is certifiable by international or national institutions of the payment industry. The hardware components and software components are implemented in accordance with standards defined in specifications for PIN Entry Devices (PED) of the Payment Card Industry (PCI). The host device further comprises a communication channel protocol for directing communications between the STM and the financial institutions via the interface.

In general in another aspect the invention features a method for performing secure electronic payment transactions. The method includes providing a secure transaction module (STM) comprising one or more hardware components and one or more software components for providing secure payment transactions utilizing banking cards. Next, providing a host device comprising a communication modem for connecting to a financial institution via a network. Next, connecting the STM to the host device via an interface and communicating between the STM and the financial institution via the communication modem for performing the secure electronic payment transactions. The method also includes the step of the STM receiving payment transaction commands from the host device via the interface.

In general in another aspect the invention features a secure transaction module (STM) adapted to provide secure payment transactions utilizing banking cards. The STM includes one or more hardware components, one or more software components, and a cryptographic boundary comprising security measures that detect and prevent tampering with the hardware components and the software components. The STM is adapted to connect to a host device via an interface and to communicate with a financial institution via a communication modem of the host device. The cryptographic boundary does not allow the secure payment transactions to be compromised by the host device or other external devices. The STM is also adapted to receive payment transaction commands from the host device via the interface.

Among the advantages of this invention may be one or more of the following. The STM is highly portable, modular, and configurable. It can be used in combination with various types of host devices and applications without needing to be re-certified by the financial institutions. It can be built into a low cost low functionality device for accepting payments or into a high cost high functionality device with many additional features.

### BRIEF DESCRIPTION OF THE DRAWINGS

FIG. 1 is a block diagram of a payment system that utilizes a Secure Transaction Module;

FIG. 2 is a block diagram of the Secure Transaction Module;

FIG. 3 is a diagram illustrating the information flow protocols;

FIG. 4 is a diagram illustrating the Payment Application Commanding Protocol (PACP);

FIG. 5 is a diagram illustrating the User Input Control Protocol;

FIG. 6 is a diagram illustrating the Magnetic Stripe Reader Control Protocol;

FIG. 7 is a diagram illustrating the Printer Control Protocol;

FIG. 8 is a diagram illustrating the Screen Control Protocol; and

FIG. 9 is a diagram illustrating the Smart Card Control Protocol.

### DETAILED DESCRIPTION OF THE INVENTION

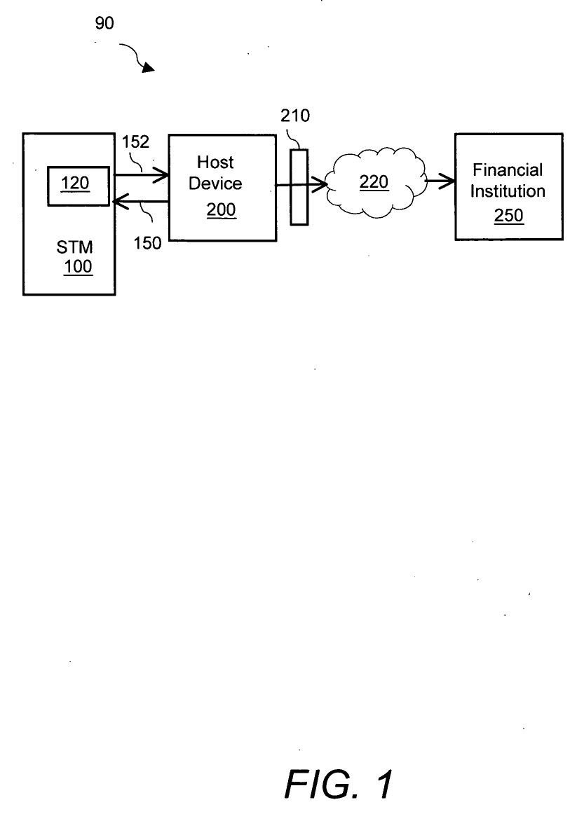

The present invention relates to a system and method for a secure transaction module (STM) that performs electronic transactions by interacting with payment cards or authentication cards. Referring to FIG. 1, a secure transaction system 90 includes STM 100 that connects to a host device 200 via an interface 120. The STM 100 utilizes the communications modem 210 of the host device to connect to a financial institution 250 via a network 220 for performing secure electronic transactions. In one example the host device 200 is a mobile phone. In other examples, the host device 200 may be a personal digital assistant (PDA), a computer, a set top box, a vending machine, a wired phone, a Point of Sale (POS) terminal, a computer controlling a car, or an electronic lock preventing access to valuable assets and/or services. The self-contained STM 100 is certifiable as a POS module and meets the Pin Entry Device (PED) certification requirements of the Payment Card Industry (PCI). The STM 100 may also be certified to meet the requirements of the Europay MasterCard Visa (EMV) Level 1 and 2 certifications, the Bank Card Testing Center of China (BCTC) certification, the Zentraler Kreditausschuss (ZKA) of Germany certification, the Interac certification of Canada, and/or other payment certification standards. The STM 100 includes transaction applications that allow it to perform secure payment transactions without the need for recertification of the combined system 90 of the STM 100 with the host device 200.

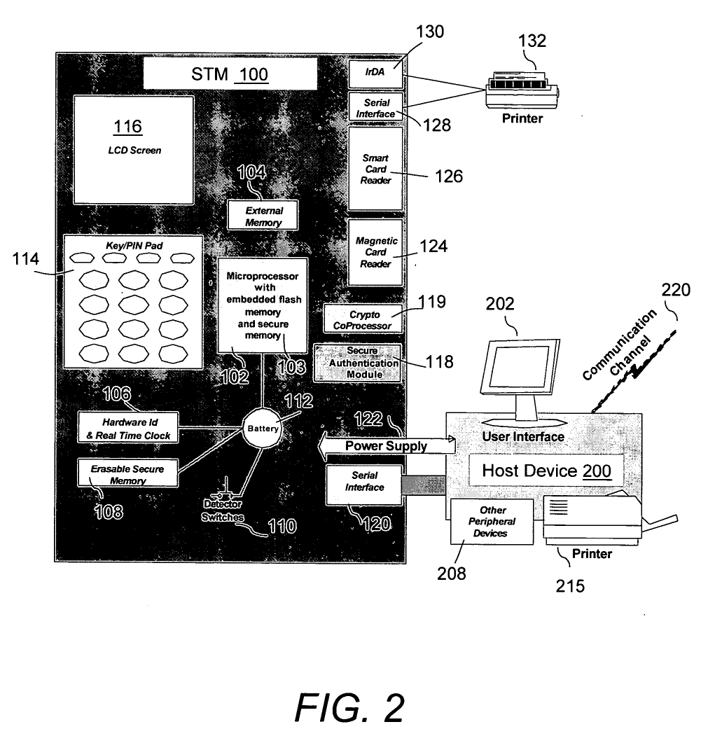

Referring to FIG. 2, the STM 100 is a self-sufficient and self-contained transaction/payment enabling module. It contains all of the hardware and software components that are required to process electronically payment transactions utilizing payment cards.

The main Printed Circuit Board Assembly (PCBA) of the STM 100 includes the following hardware components:

Microprocessor. Microprocessor 102 executes the above mentioned transaction application programs. It is powered by a power supply 122 that is external to the PCBA. In the embodiment of FIG. 2 the external power supply 122 is provided by the host device 200. In other embodiments the power supply 122 may be a separate stand alone power supply or may be provided by other peripheral devices. Microprocessor 102 has an embedded secure microprocessor (not shown) and an embedded secure memory 103 that is used to store programs and data. In other embodiments, the secure microprocessor or the secure memory 103 reside on the PCBA outside of the microprocessor 102 and are addressable by the microprocessor 102. Besides the embedded secure memory, the microprocessor 102 may have an interface to an external memory 104 and to an erasable secure memory 108. These memory blocks 104, 108 reside on the PCBA.

Secure microprocessor. The secure microprocessor provides a secure environment for the execution of the transaction application programs. It has an embedded secure memory and utilizes external power from the main PCBA life-time battery 112 for powering up the embedded secure memory. In other embodiments, the secure memory may be an external memory 104 addressable by the secure microprocessor. The secure microprocessor uses the external power supply 122 to power up the execution of the transaction application programs.

Memory. The STM 100 has a secure memory 103 embedded in the main microprocessor, a secure memory embedded in the secure microprocessor (not shown), a secure memory on the PCBA 104, and permanent storage memory on the PCBA 108.

Magnetic Stripe Card Reader. The STM 100 has a connector 124 for connecting to a magnetic stripe card reader. A magnetic stripe card reader is connected to connector 124.

Smart Card Reader. The STM 100 has a connector 126 for connecting to a smart card reader. A smart card reader is connected to connector 126.

Life-time battery. A Life-time battery 112 resides on the PCBA and provides power to the secure memory 103 and clock 106.

LCD and Key pad. The STM has a connector for a Liquid Crystal Display (LCD) screen 116 and a connector for a key pad 114. The LCD screen 116 is connected to the LCD connector of the STM and the key pad 114 is connected to the keypad connector of the STM.

Connectors for other card readers including a contactless card readers or a biometric card reader (not shown).

A slot for receiving a removable Secure Authentication Module (SAM) 118. A SAM 118 is an electronic device (usually just a single electronic chip) that provides physical security for the authentication software that runs on the chip. The authentication software utilizes cryptographic algorithms and encryption keys that are stored in the secured memory of the chip. The secure chip that is used for the SAM is commercially available. Some of the SAMs are using operating environments that are standardized and commercially available as well. Authentication software that resides in this operational environment usually is proprietary and provided by the SAM issuing organization. SAMs with the operation environment but without authentication software can be purchased from several vendors trading on the web, i.e. Gemplus, MAOSCO, Keycorp., among others.

A Crypto coprocessor 119 is a specialized processor that is capable to perform complex mathematical calculations that are required for cryptographical data transformations. Since these processors are not intended to be used in a standalone mode usually they are physically packaged together with the common microprocessor. Since this combined chip that includes both the common processor and the crypto coprocessor is intended to be used for security purposes, it also contains secure memory that can store sensitive data such as cryptographic keys. One example of this combined chip is the Secure Authentication Module (SAM).

Interface 120 for connecting to the processor of the host device 200. The STM 100 utilizes the communications modem 210 and the communication protocol (not shown) of the host device 200 for connecting to the various financial institutions 250 via the network 220. Interface 120 may be a serial, parallel or other special interfaces such a Subscriber Identification Module (SIM) card interface, or a multimedia card interface. The STM processor 102 that runs the secure transaction applications is separate from the processor of the host device that runs the communication protocol application.

Input for an external power supply source 122. External power may be provided by the power supply of the host device 200, as shown in FIG. 2, or by a standalone power supply or a power supply of another peripheral device.

In addition to the above mentioned hardware components that are included in the PCBA of the STM 100, the STM requires an external power supply and an external communication channel to successfully perform secure electronic transaction with the financial institution 250.

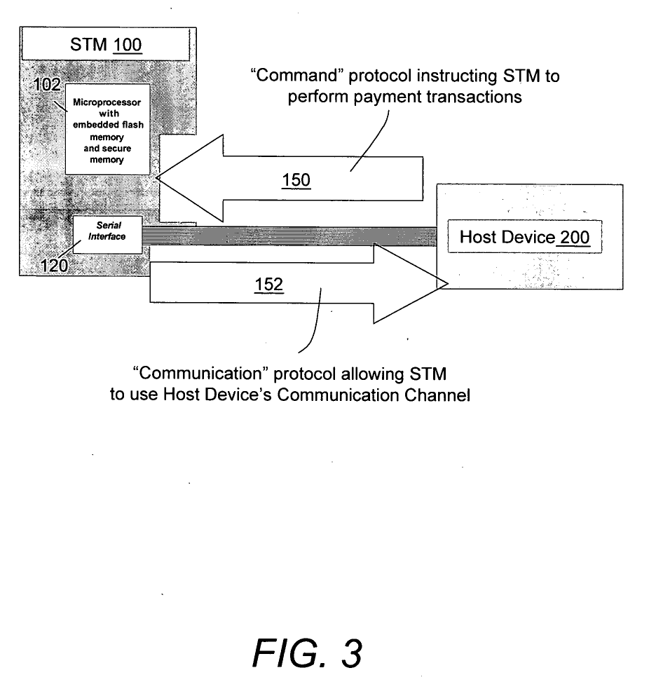

A unique feature of the STM 100, is that the STM 100 does not only send transactions via the interface 120 and through the modem 210 of the host device 200, but the STM 100 enables the host device 200 to also command the STM to conduct the various transactions. Referring to FIG. 3, the STM 100 connects via the interface 120 to the host device 200 and utilizes the host devices communication protocol for connecting via the host device's modem 210 to a financial institution 250 for performing a secure transaction (152). The interface connection also allows the host device 200 to utilize the “command” protocols of the STM to instruct the STM 100 to perform a secure transaction (150). The STM 100 has the unique ability to have its own “cryptographic boundary” so that secure payment and other transactions are not compromised by the host device 200. This “cryptographic boundary” includes security measures that detect and prevent tampering with the hardware and software components of the STM that are used for transaction processing. All sensitive information that is processed within this “cryptographic boundary” is encrypted before it is exposed to the host device. Furthermore, the STM maintains this “cryptographic boundary” between different transaction applications that are contained within its memory, thereby allowing multiple authorities to house approved and secure transactions processing methodologies.

The main software components of the STM 100 include the following “command” protocols:

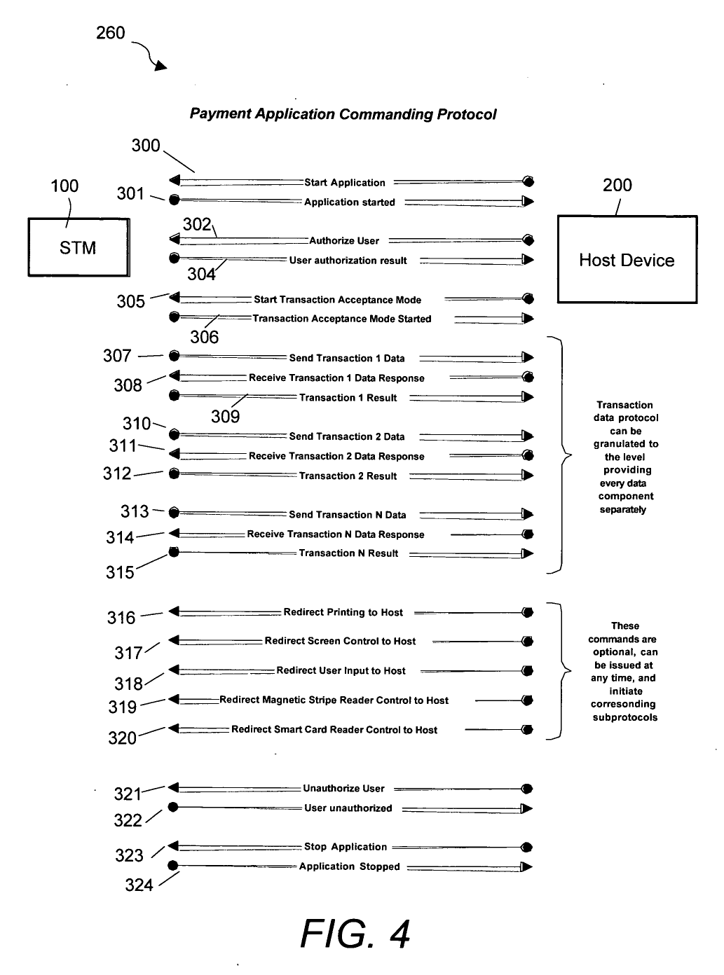

Transaction Application Commanding Protocol. The transaction application commanding protocol allows external control of the transaction application. In one example the transaction application is a payment application. Referring to FIG. 4 the information flow of a Payment Application Commanding Protocol (PACP) 260 includes the following steps. First the host device 200 instructs the STM to start the payment application (300). In one example, step 300 is initiated by a user input through the host device's user interface. The STM 100 starts the payment application and notifies the host device 200 (301). The host device request user authorization (302) and the STM processes the authorization and sends the user authorization result to the host device (304). Next the host device requests staring the transaction acceptance mode (305) and the STM starts the transaction acceptance mode and notifies the host device (306). The STM sends data for transaction 1 to the host device (307), the host device sends the response to the transaction 1 data to the STM (308) and the STM sends the transaction 1 result to the host device (309). Steps 307 to 309 are repeated for every following transaction 2 to N (310-312) to (313-315), respectively. The transaction data protocol can be granulated to a level of providing every single data component separately. Upon completion of all payment transactions the host device asks the STM to unauthorize the user (321) and to stop the application (323) and the STM unauthorizes the user (322) and stops the application (324). The payment application may also include commands for redirecting printing to the host device (316), commands for redirecting screen control to the host device (317), commands for redirecting user input to the host device (318), commands for redirecting magnetic stripe card reader control to the host device (319) and commands for redirecting smart card reader control to the host device (320). These commands can be issued at any time and initiate corresponding protocols.

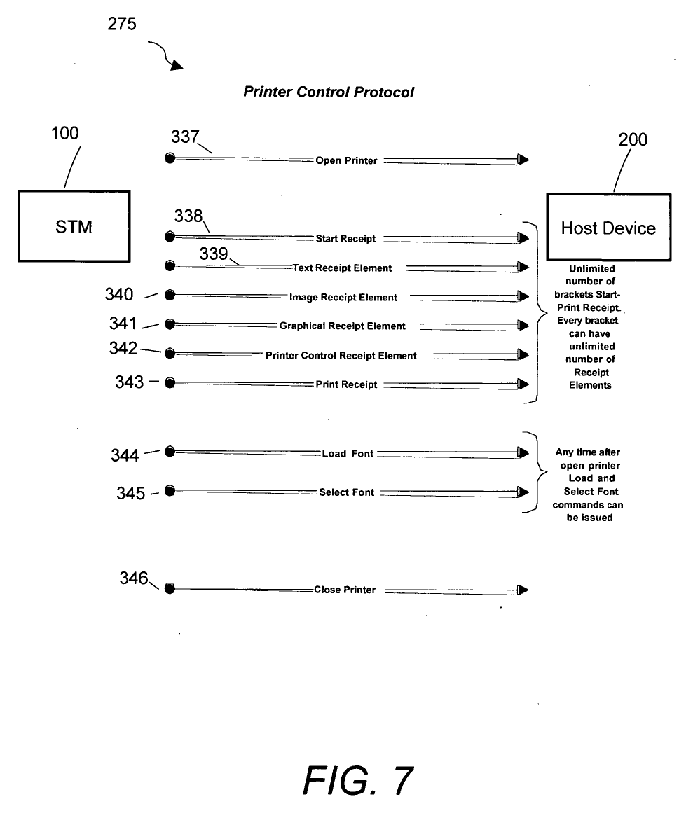

Printing Device Protocol. The printing device protocol 275 is a sub protocol of the Transaction Application Commanding Protocol 260. The host device uses the printing device protocol 275 to redirect printed forms of the transaction application to the host device. The host device can then modify and/or print these forms using printers that are attached directly to the host device. Referring to FIG. 7, upon receiving a “redirect printing control to host” command (316) from the host device, the STM sends a command to the host device to open printer (337) and to start receipt (338). The STM then sends a text receipt element (339), an image receipt element (340), a graphical receipt element (341), and a printer control receipt element (342). The STM then sends a command to print receipt (343). This process continues for any number of start to print receipt brackets until the STM sends a notification to the host device to close printer (346). Each start to print receipt bracket may have any number of receipt elements including image, text, graphics and printer control elements. Any time after the open printer command, a command to load a font (344) and to select a font (345) may be issued from the STM to the host device.

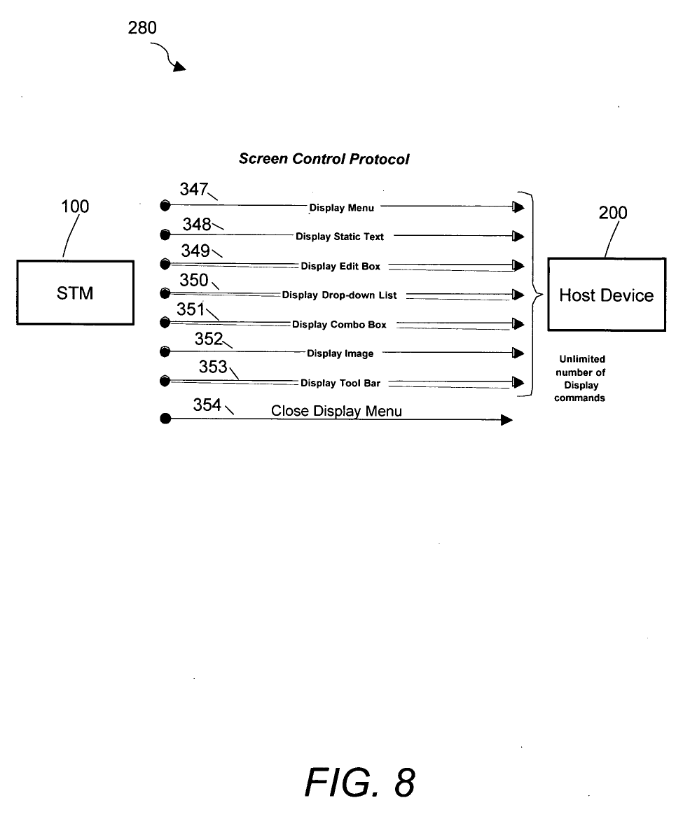

Screen Control Protocol. The screen control protocol 280 is a sub protocol of the Transaction Application Commanding Protocol 260. The host device uses the screen control protocol 280 to redirect the video output of the transaction application to the host device. The host device can then can modify the elements of the video output and/or display them on a video monitor that is attached to the host device. Referring to FIG. 8, upon receiving a “redirect screen control to host” command (317) from the host device, the STM sends a command to the host device to start the display menu (347) and to display static text (348), to display edit box (349), to display drop-down list (350), to display combo box (351), to display image (352) and to display tool bar (353). This process continues for any number of display commands until the STM sends a notification to the host device to close the display menu (354).

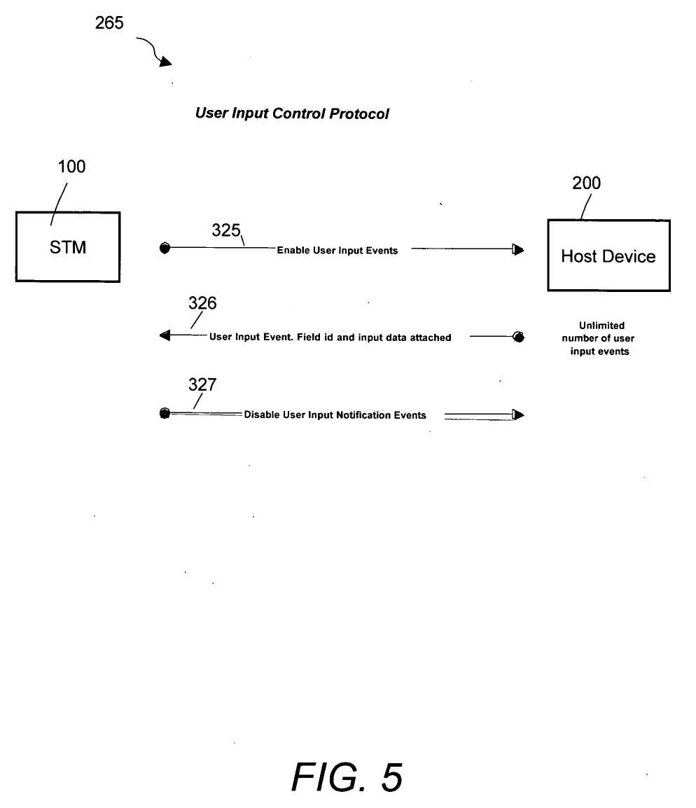

User Input Control Protocol. The User Input Control Protocol 265 is a sub protocol of the Transaction Application Commanding Protocol 260. The host device uses the user input control protocol 265 to redirect user input to the keyboard of the host device. This allows a use to enter input to the transaction application of the STM through the host device's keyboard. Referring to FIG. 5, upon receiving a “redirect user input to host device” command (318) from the host device, the STM requests the host device to enable user input events (325). The host device then sends a user input event and attaches the field identification and input data (326). This process continues for any number of user input events until the STM sends a notification to the host device to disable the user input events (327).

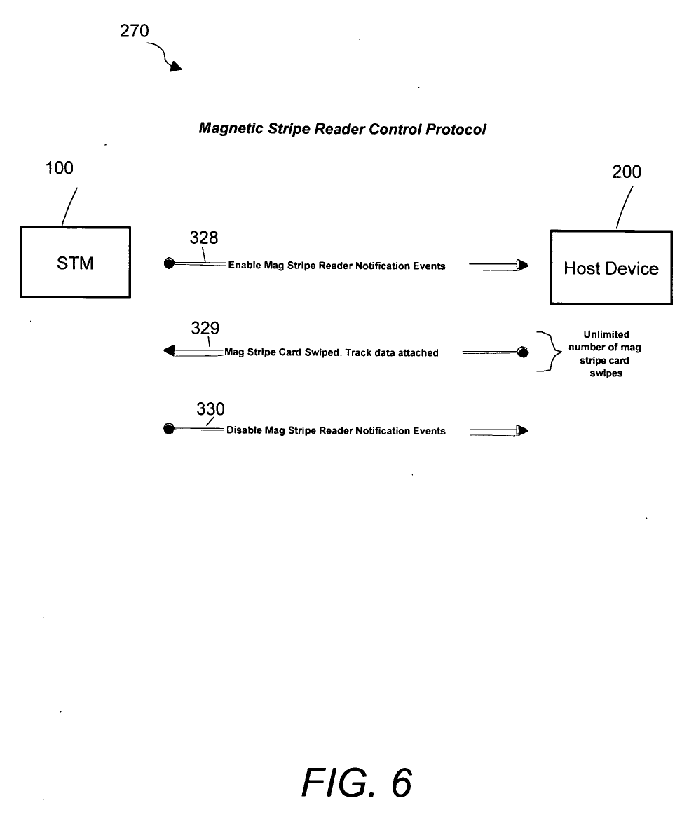

Magnetic Stripe Reader Control Protocol. The Magnetic Stripe Reader Control Protocol 270 is a sub protocol of the Transaction Application Commanding Protocol 260. The host device uses the magnetic stripe reader control protocol 270 to redirect magnetic card information input to a magnetic card reader that is attached directly to the host device. Referring to FIG. 6, upon receiving a “redirect magnetic strip reader control to host” command (319) from the host device, the STM requests the host device to enable magnetic stripe reader notification events (328). A magnetic card is swiped in the magnetic card reader that is attached to the host device and the magnetic card information is send to the STM (329). This process continues for any number of magnetic card swipes and magnetic card information until the STM sends a notification to the host device to disable the magnetic card reader events (330).

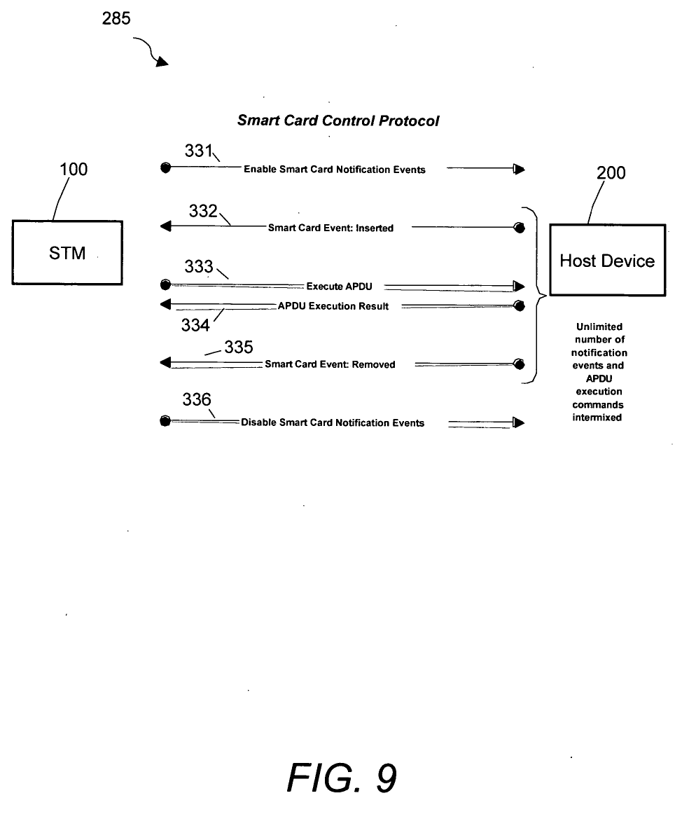

Smart Card Reader Control Protocol. The Smart Card Reader Control Protocol 285 is a sub protocol of the Transaction Application Commanding Protocol 260. The host device uses the smart card reader control protocol 270 to redirect smart card information input to a smart card reader that is attached directly to the host device. Referring to FIG. 9, upon receiving a “redirect smart card reader control to host” command (320) from the host device, the STM requests the host device to enable smart card reader notification events (331). A smart card is swiped in the smart card reader that is attached to the host device and the smart card information is send to the STM (332). The STM sends a request to the host device to execute an Application Protocol Data Unit (APDU) (333) and the host device sends the APDU execution result to the STM (334). This process continues for any number of smart card events and APDU execution commands until the smart card is removed from the card reader attached to the host device and the information is sent to the STM (335). The STM sends a notification to the host device to disable the smart card reader events (336).

In addition to payment transactions, an STM may be used to perform transactions including secure transfer of information (i.e., transfer of personal medical and or financial information) and secure electronic transactions, such as electronic tax filings, electronic patent and trademark filings, electronic corporate filings, electronic voting, and electronic locks, among others.

Several embodiments of the present invention have been described. Nevertheless, it will be understood that various modifications may be made without departing from the spirit and scope of the invention. Accordingly, other embodiments are within the scope of the following claims.

What is claimed is:

1. A secure electronic payment transaction system comprising:
a secure transaction module (STM) comprising one or more hardware components and one or more software components for providing secure payment transactions utilizing banking cards;
a host device comprising a communication modem for connecting to a financial institution via a network;
wherein said STM is adapted to connect to said host device via an interface and to communicate with said financial institution via said communication modem; and
wherein said STM is further adapted to receive payment transaction commands from said host device via said interface.

2. The system of claim 1 wherein said STM provides a cryptographic boundary so that said secure payment transactions are not compromised by said host device or other external devices and wherein said cryptographic boundary comprises security measures that detect and prevent tampering with said one or more hardware components and said one or more software components.

3. The system of claim 2 wherein all sensitive information processed within said cryptographic boundary is encrypted before being exposed to said host device.

4. The system of claim 1 wherein said one or more hardware components are contained in a Printed Circuit Board Assembly (PCBA) of said STM and comprise a microprocessor, a secure microprocessor and a memory.

5. The system of claim 4 wherein said secure microprocessor is integrated within said microprocessor.

6. The system of claim 5 wherein said memory is selected from a group consisting of memory embedded in said microprocessor, memory embedded in said secure microprocessor, erasable secure memory embedded in said PCBA, and permanent secure storage memory embedded in said PCBA.

7. The system of claim 4 wherein said one or more hardware components further comprise a display screen, a keypad, a clock and a life-time battery providing power to said secure memory and said clock.

8. The system of claim 7 wherein said one or more hardware components further comprise a first connector adapted to connect to a magnetic card reader, a second connector adapted to connect to a smart card reader, and a third connector adapted to connect to a secure authentication module (SAM).

9. The system of claim 8 wherein said one or more hardware components further comprise additional connectors adapted to connect to card readers selected from a group consisting of contactless card readers and biometric readers.

10. The system of claim 4 wherein said one or more hardware components further comprise a crypto coprocessor, and wherein said crypto coprocessor is adapted to perform complex mathematical calculations required for cryptographic data transformations.

11. The system of claim 4 wherein said one or more hardware components further comprise additional interfaces for connecting to external devices and wherein said additional interfaces are selected from a group consisting of serial interfaces, parallel interfaces, infrared interfaces, and Bluetooth.

12. The system of claim 4 wherein said microprocessor is powered by an external power supply.

13. The system of claim 12 wherein said external power supply is provided by said host device.

14. The system of claim 1 wherein said interface provides a processor to processor interface between the STM and the host device and is selected from a group consisting of a serial interface, parallel interface, Subscriber Identification Module (SIM) card interface, and multimedia card interfaces.

15. The system of claim 1 wherein said host device is selected from a group consisting of a mobile phone, a personal computer, a point of sale (POS) terminal, a personal digital assistant (PDA), a set-top box, a vending machine, a wired telephone, a computer controlling a car, and an electronic lock preventing access to valuable assets.

16. The system of claim 1 wherein said one or more software components comprise a secure transaction application and a transaction application commanding protocol (TACP) and wherein said TACP allows external control of said secure transaction application.

17. The system of claim 16 wherein said one or more software components further comprise a printing device protocol and wherein said printing device protocol directs printed forms of said secure transaction application to a printer connected to said host device.

18. The system of claim 16 wherein said one or more software components comprise a screen control protocol and wherein said screen control protocol directs video output of said secure transaction application to a screen display of said host device.

19. The system of claim 16 wherein said one or more software components comprise a user input control protocol and wherein said user input control protocol directs user input to said secure transaction application to a keyboard of said host device.

20. The system of claim 16 wherein said one or more software components comprise a magnetic card reader control protocol and wherein said magnetic card reader control protocol directs magnetic card information input to a magnetic card reader connected to said host device.

21. The system of claim 16 wherein said one or more software components comprise a smart card reader control protocol and wherein said smart card reader control protocol directs smart card information input to a smart card reader connected to said host device.

22. The system of claim 1 wherein said STM is certifiable by international or national institutions of the payment industry.

23. The system of claim 1 wherein said one or more hardware components and said one or more software components are implemented in accordance with standards defined in a specification for PIN Entry Devices (PED) of the Payment Card Industry (PCI).

24. The system of claim 1 wherein said host device further comprises a communication channel protocol for directing communications between said STM and said financial institutions via said interface.

25. A method for performing secure electronic payment transactions comprising:
providing a secure transaction module (STM) comprising one or more hardware components and one or more software components for providing secure payment transactions utilizing banking cards;
providing a host device comprising a communication modem for connecting to a financial institution via a network;
connecting said STM to said host device via an interface; and
communicating between said STM and said financial institution via said communication modem and performing said secure electronic payment transactions.

26. The method of claim 25 further comprising said STM receiving payment transaction commands from said host device via said interface.

27. The method of claim 25 wherein said STM provides a cryptographic boundary so that said secure payment transactions are not compromised by said host device or other external devices and wherein said cryptographic boundary comprises security measures that detect and prevent tampering with said one or more hardware components and said one or more software components.

28. The method of claim 27 wherein all sensitive information processed within said cryptographic boundary is encrypted before being exposed to said host device.

29. The method of claim 25 wherein said one or more hardware components are contained in a Printed Circuit Board Assembly (PCBA) of said STM and comprise a microprocessor, a secure microprocessor and a memory.

30. The method of claim 29 wherein said secure microprocessor is integrated within said microprocessor.

31. The method of claim 30 wherein said memory is selected from a group consisting of memory embedded in said microprocessor, memory embedded in said secure microprocessor, erasable secure memory embedded in said PCBA, and permanent secure storage memory embedded in said PCBA.

32. The method of claim 30 wherein said one or more hardware components further comprise a display screen, a keypad, a clock and a life-time battery providing power to said secure memory and said clock.

33. The method of claim 32 wherein said one or more hardware components further comprise a first connector adapted to connect to a magnetic card reader, a second connector adapted to connect to a smart card reader, and a third connector adapted to connect to a secure authentication module (SAM).

34. The method of claim 33 wherein said one or more hardware components further comprise additional connectors adapted to connect to card readers selected from a group consisting of contactless card readers and biometric readers.

35. The method of claim 30 wherein said one or more hardware components further comprise a crypto coprocessor, and wherein said crypto coprocessor is adapted to perform complex mathematical calculations required for cryptographic data transformations.

36. The method of claim 30 wherein said one or more hardware components further comprise additional interfaces for connecting to external devices and wherein said additional interfaces are selected from a group consisting of serial interfaces, parallel interfaces, infrared interfaces, and Bluetooth.

37. The method of claim 30 wherein said microprocessor is powered by an external power supply.

38. The method of claim 37 wherein said external power supply is provided by said host device.

39. The method of claim 25 wherein said interface provides a processor to processor interface between the STM and the host device and is selected from a group consisting of a serial interface, parallel interface, Subscriber Identification Module (SIM) card interface, and multimedia card interfaces.

40. The method of claim 25 wherein said host device is selected from a group consisting of a mobile phone, a personal computer, a point of sale (POS) terminal, a personal digital assistant (PDA), a set-top box, a vending machine, a wired telephone, a computer controlling a car, and an electronic lock preventing access to valuable assets.

41. The method of claim 25 wherein said one or more software components comprise a secure transaction application and a transaction application commanding protocol (TACP) and wherein said TACP allows external control of said secure transaction application.

42. The method of claim 41 wherein said one or more software components further comprise a printing device protocol and wherein said printing device protocol directs printed forms of said secure transaction application to a printer connected to said host device.

43. The method of claim 41 wherein said one or more software components comprise a screen control protocol and wherein said screen control protocol directs video output of said secure transaction application to a screen display of said host device.

44. The method of claim 41 wherein said one or more software components comprise a user input control protocol and wherein said user input control protocol directs user input to said secure transaction application to a keyboard of said host device.

45. The method of claim 41 wherein said one or more software components comprise a magnetic card reader control protocol and wherein said magnetic card reader control protocol directs magnetic card information input to a magnetic card reader connected to said host device.

46. The method of claim 41 wherein said one or more software components comprise a smart card reader control protocol and wherein said smart card reader control protocol directs smart card information input to a smart card reader connected to said host device.

47. The method of claim 25 wherein said STM is certifiable by international or national institutions of the payment industry.

48. The method of claim 25 wherein said one or more hardware components and said one or more software components are implemented in accordance with standards defined in a specification for PIN Entry Devices (PED) of the Payment Card Industry (PCI).

49. The method of claim 25 wherein said host device further comprises a communication channel protocol for directing communications between said STM and said financial institutions via said interface.

50. A secure transaction module (STM) adapted to provide secure payment transactions utilizing banking cards, said STM comprising:
one or more hardware components,
one or more software components,
a cryptographic boundary comprising security measures that detect and prevent tampering with said one or more hardware components and said one or more software components;
wherein said STM is adapted to connect to a host device via an interface and to communicate with a financial institution via a communication modem of said host device; and
wherein said cryptographic boundary does not allow said secure payment transactions to be compromised by said host device or other external devices.

51. The STM of claim 51 wherein said STM is adapted to receive payment transaction commands from said host device via said interface.
